(19) United States
(12) Patent Application Publication
(10) Pub. No.: US 2009/0091912 A1
(43) Pub. Date: Apr. 9, 2009

(54) Light-guiding key structure with lateral light-guiding function

(76) Inventor: Hsin-Chin Lee, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,997

(22) Filed: Oct. 9, 2007

(51) Int. Cl. G01D 11/28

(52) U.S. Cl. 362/30

(57) ABSTRACT

A light-guiding key structure with lateral light-guiding function includes: at least one key module, a light-guiding element, and at least one light-emitting element. The at least one key module can be a key body or a key display. The light-guiding element is disposed over the at least one key module. The at least one light-emitting element is disposed beside one side of the light-guiding element. Therefore, when the at least one light-emitting element projects a light source to the light-guiding element, the light source is guided via the light-guiding element onto the at least one key module to illuminate the image on the at least one key module for user to watch the image.

### BACKGROUND OF THE INVENTION

1. Field of the Invention

The present invention relates to a light-guiding key structure, and particularly relates to a light-guiding key structure with lateral light-guiding function.

2. Description of the Related Art

With the development of information technologies and the advance of network technologies, mobile phones (or cell phones) have grown to be one of the most widespread communication tools. Cell phones have become increasingly popular for consumers due to small size, portability, versatile function, and most importantly, their steadily decreasing price. In terms of purchasing cell phones, the appearance and functions are the determining factors for a majority of buyers. Hence, the market responds to this trend by placing multi-functional, new and attractive cell phones on the market.

In order to illuminate transparent words on the top surface of the key pads of a mobile phone, an LED is generally arranged under the key pads to generate a light. Moreover, the light passes through a rubber layer of the mobile phone and is transmitted upward to illuminate the transparent words on the key pad due to the material property of the rubber material.

However, the transparency of the rubber material is low. Hence, when passing through the rubber layer large amounts of light is absorbed and lost, and the light cannot be transmitted to further areas. Moreover, in the prior art when a designer wanted to illuminate the transparent words, he or she needed to use 6-8 LEDs as the lights.

Some designers use a rubber material with high transparency for reducing light loss. However, there still needs to be at least 4 LEDs as a light. Hence, in the prior the transmission efficiency and uniform property for lights are bad.

### SUMMARY OF THE INVENTION

One particular aspect of the present invention is to provide a light-guiding key structure with lateral light-guiding function. The present invention has a light-guiding material or a light-guiding structure disposed on/above a key body or a key display. Hence, light source can be guided to pass through the opaque key body or the opaque key display via the light-guiding material or the light-guiding structure. Hence, the object of the present invention is that “the position of the light source is changed from a bottom side of the key body (the prior art) to a lateral side of the key body (the present invention)” and “a high contract background/caption is applied to the present for users to watch the image from the key body or the key display.

In order to achieve the above-mentioned aspects, the present invention provides a light-guiding key structure with lateral light-guiding function includes: at least one key module, a light-guiding element, and at least one light-emitting element. The at least one key module can be a key body or a key display. The light-guiding element is disposed over the at least one key module. The at least one light-emitting element is disposed beside one side of the light-guiding element. Therefore, when the at least one light-emitting element projects a light source to the light-guiding element, the light source is guided via the light-guiding element onto the at least one key module to illuminate the image on the at least one key module for user to watch the image.

Moreover, according to designer's needs the light-guiding element can be following any one aspect:

1. The light-guiding element is a one-piece light-guiding board.

2. The light-guiding element includes a light-guiding board with a first refractive index, a plurality of micro concave grooves formed on a surface of the light-guiding board, and a plurality of micro light-guiding bodies respectively filled into the micro concave grooves, and each micro light-guiding body has a second refractive index different from the first refractive index of the light-guiding board.

3. The light-guiding element includes a light-guiding board, a plurality of micro concave grooves formed on a surface of the light-guiding board, and a transparent protective layer formed on the surface of the light-guiding board for covering the micro concave grooves.

4. The light-guiding element includes a light-guiding board and a PBS (Polarizing Beam Splitter) module disposed in the light-guiding board. The PBS module is composed of a plurality of polarizing beam splitting prisms or polarizing beam splitting boards. The polarizing beam splitting prisms or polarizing beam splitting boards slantwise face to the at least one light-emitting element and the at least one key module for reflecting S-polarization or P-polarization of the light source from the at least one light-emitting element to the at least one key module.

Furthermore, the light-guiding key structure further includes a light-transmitting material disposed beside or covered around the at least one light-emitting element for transmitting the light source from different directions into the light-guiding element.

Because the light-guiding material or the light-guiding structure of the present invention is disposed on/above the key body or the key display, the present invention utilizes less light sources to shows images with high brightness and high uniformity. The present invention has the following characteristics:

1. The present invention makes “point light source” transmitted into “face light source”, so less light-emitting elements can generate light source with high brightness. Hence brightness efficiency is increased.

2. Because the usage quantity of LEDs is decreased, the usage quantity of batteries is decreased. Hence, the charging frequency is decreased and the life of the battery is increased.

3. The present invention can use capacitance key module or keypad display, so the light-guiding key structure has a press-press function.

4. The opaque key body or the opaque key display can be applied to the present invention.

5. Because the light source is transmitted from “point light source” into “face light source”, so the entirety height of the present invention is decreased.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a cross-sectional, schematic view of a light-guiding key structure with lateral light-guiding function according to the first embodiment of the present invention;

FIG. 2 is a cross-sectional, schematic view of a light-guiding key structure with lateral light-guiding function according to the second embodiment of the present invention;

FIG. 3 is a cross-sectional, schematic view of a light-guiding key structure with lateral light-guiding function according to the third embodiment of the present invention;

FIG. 4 is a cross-sectional, schematic view of a light-guiding key structure with lateral light-guiding function according to the fourth embodiment of the present invention;

FIG. 5 is a cross-sectional, schematic view of a light-guiding key structure with lateral light-guiding function according to the fifth embodiment of the present invention;

FIG. 6 is a cross-sectional, schematic view of a light-guiding key structure with lateral light-guiding function according to the sixth embodiment of the present invention;

FIG. 7 is a cross-sectional, schematic view of a light-guiding key structure with lateral light-guiding function according to the seventh embodiment of the present invention;

FIG. 8 is a cross-sectional, schematic view of a light-guiding key structure with lateral light-guiding function according to the eight embodiment of the present invention;

FIG. 9 is a schematic view of a light-transmitting material disposed beside a light-emitting element according to the present invention; and

FIG. 10 is a schematic view of a light-transmitting material covered around a light-emitting element according to the present invention.

### DETAILED DESCRIPTION OF THE PREFERRED EMBODIMENTS

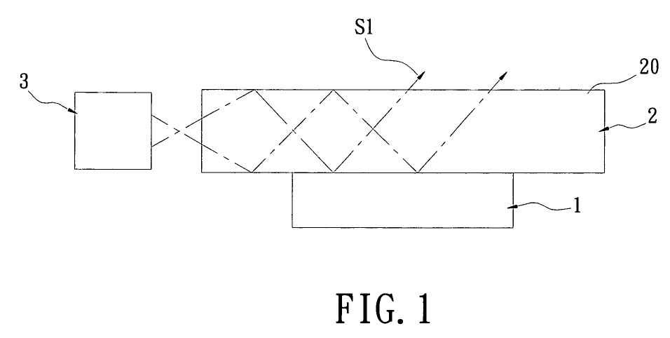

Referring to FIG. 1, the first embodiment of the present invention provides a light-guiding key structure with lateral light-guiding function, including at least one key module 1, a light-guiding element 2, and at least one light-emitting element 3.

The at least one key module 1 is an opaque. The at least one key module 1 is a key body or a key display. The light-guiding element 2 abuts against a top surface of the at least one key module 1. The light-guiding element 2 is a light-guiding board 20. The at least one light-emitting element 3 is disposed beside one side of the light-guiding element 2. The at least one light-emitting element 3 can be an LED or is composed of a plurality of LEDs.

Therefore, when the at least one light-emitting element 3 projects a light source S1 to the light-guiding element 2, the light source S1 is guided via the light-guiding element 2 onto the at least one key module 1 to illuminate images (not shown) on the at least one key module 1 for user to watch the images. In other words, the at least one light-emitting element 3 provides the lateral light source S1 and the light-guiding element 2 guides the lateral light source S1 to illuminate a background or a caption that is formed on the at least one key module 1 for user to watch the shining background or caption. The background or the caption can be patterns, symbols, words or numbers.

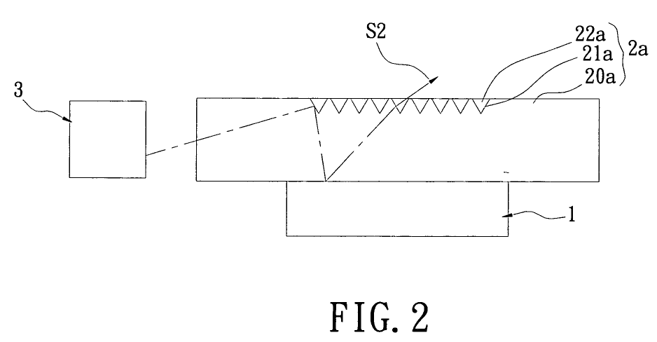

Referring to FIG. 2, the second embodiment of the present invention provides a light-guiding key structure with lateral light-guiding function, including at least one key module 1, a light-guiding element 2a, and at least one light-emitting element 3.

The difference between the second embodiment and the first embodiment is that the light-guiding element 2a includes a light-guiding board 20a with a first refractive index, a plurality of micro concave grooves 21a formed on a top surface of the light-guiding board 20a, and a plurality of micro light-guiding bodies 22a respectively filled into the micro concave grooves 21a. Moreover, each micro light-guiding body 22a has a second refractive index different from the first refractive index of the light-guiding board 20a.

Therefore, when the at least one light-emitting element 3 projects a light source S2 to the light-guiding element 2a, the light source S2 is guided via the light-guiding element 2a (via matching the light-guiding board 20a and the micro light-guiding bodies 22a) onto the at least one key module 1 to illuminate images (not shown) on the at least one key module 1 for user to watch the images.

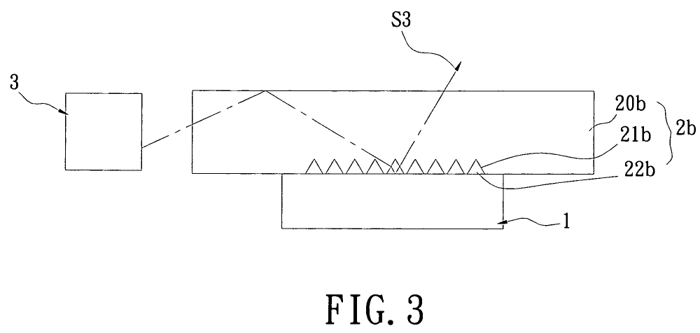

Referring to FIG. 3, the third embodiment of the present invention provides a light-guiding key structure with lateral light-guiding function, including at least one key module 1, a light-guiding element 2b, and at least one light-emitting element 3.

The difference between the third embodiment and the first embodiment is that the light-guiding element 2b includes a light-guiding board 20b with a first refractive index, a plurality of micro concave grooves 21b formed on a bottom surface of the light-guiding board 20b, and a plurality of micro light-guiding bodies 22b respectively filled into the micro concave grooves 21b. Moreover, each micro light-guiding body 22b has a second refractive index different from the first refractive index of the light-guiding board 20b.

Therefore, when the at least one light-emitting element 3 projects a light source S3 to the light-guiding element 2b, the light source S3 is guided via the light-guiding element 2b (via matching the light-guiding board 20b and the micro light-guiding bodies 22b) onto the at least one key module 1 to illuminate images (not shown) on the at least one key module 1 for user to watch the images.

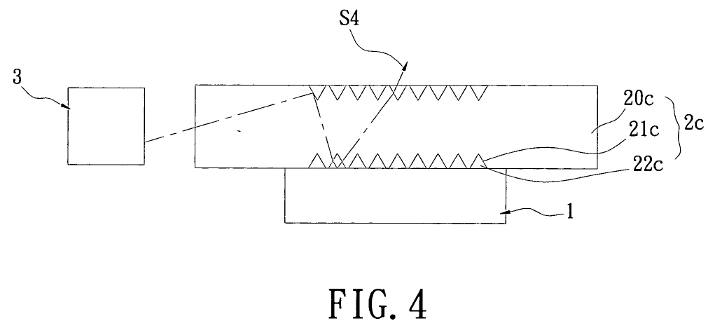

Referring to FIG. 4, the fourth embodiment of the present invention provides a light-guiding key structure with lateral light-guiding function, including at least one key module 1, a light-guiding element 2c, and at least one light-emitting element 3.

The difference between the fourth embodiment and the first embodiment is that the light-guiding element 2c includes a light-guiding board 20c with a first refractive index, a plurality of micro concave grooves 21c respectively formed on a top surface and a bottom surface of the light-guiding board 20c, and a plurality of micro light-guiding bodies 22c respectively filled into the micro concave grooves 21c. Moreover, each micro light-guiding body 22c has a second refractive index different from the first refractive index of the light-guiding board 20c.

Therefore, when the at least one light-emitting element 3 projects a light source S4 to the light-guiding element 2c, the light source S4 is guided via the light-guiding element 2c (via matching the light-guiding board 20c and the micro light-guiding bodies 22c) onto the at least one key module 1 to illuminate images (not shown) on the at least one key module 1 for user to watch the images.

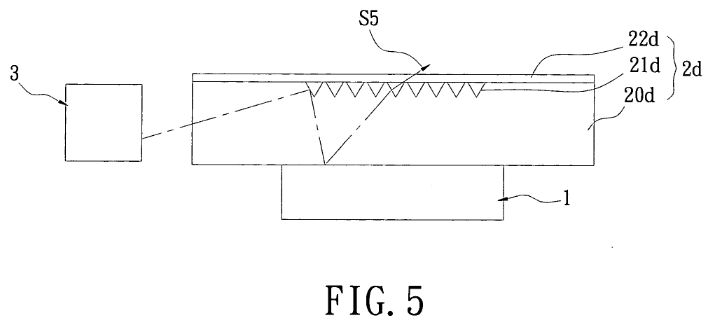

Referring to FIG. 5, the fifth embodiment of the present invention provides a light-guiding key structure with lateral light-guiding function, including at least one key module 1, a light-guiding element 2d, and at least one light-emitting element 3.

The light-guiding element 2d includes a light-guiding board 20d, a plurality of micro concave grooves 21d formed on a top surface of the light-guiding board 20d, and a transparent protective layer 22d formed on the top surface of the light-guiding board 20d for covering the micro concave grooves 21d. Hence, the difference between the fifth embodiment and the second embodiment is that there is no any material filled into the micro concave grooves 21d and the transparent protective layer 22d is covered over the micro concave grooves 21d.

Therefore, when the at least one light-emitting element 3 projects a light source S5 to the light-guiding element 2d, the light source S5 is guided via the light-guiding element 2d (via matching the light-guiding board 20d and the micro concave grooves 21d) onto the at least one key module 1 to illuminate images (not shown) on the at least one key module 1 for user to watch the images.

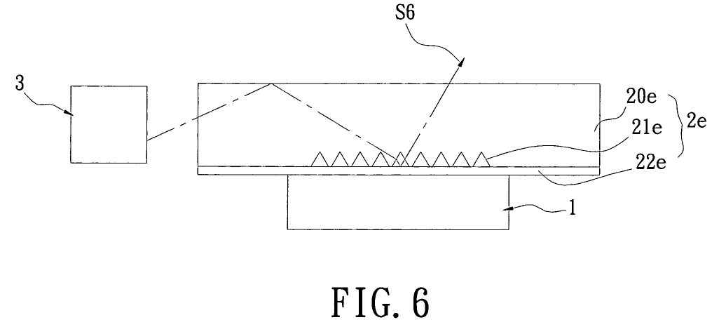

Referring to FIG. 6, the sixth embodiment of the present invention provides a light-guiding key structure with lateral light-guiding function, including at least one key module 1, a light-guiding element 2e, and at least one light-emitting element 3.

The light-guiding element 2e includes a light-guiding board 20e, a plurality of micro concave grooves 21e formed on a bottom surface of the light-guiding board 20e, and a transparent protective layer 22e formed on the bottom surface of the light-guiding board 20e for covering the micro concave grooves 21e. Hence, the difference between the sixth embodiment and the third embodiment is that there is no any material filled into the micro concave grooves 21e and the transparent protective layer 22e is covered over the micro concave grooves 21e.

Therefore, when the at least one light-emitting element 3 projects a light source S6 to the light-guiding element 2e, the light source S6 is guided via the light-guiding element 2e (via matching the light-guiding board 20e and the micro concave grooves 21e) onto the at least one key module 1 to illuminate images (not shown) on the at least one key module 1 for user to watch the images.

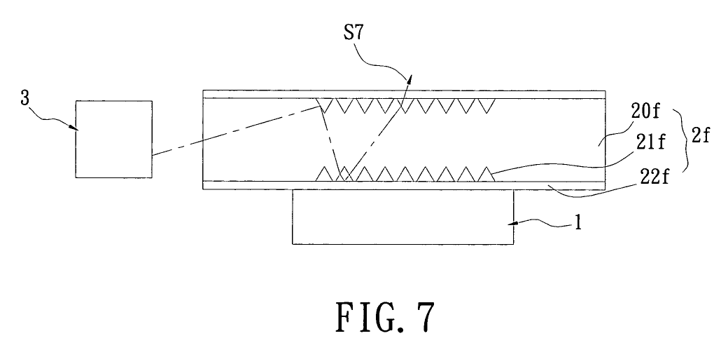

Referring to FIG. 7, the seventh embodiment of the present invention provides a light-guiding key structure with lateral light-guiding function, including at least one key module 1, a light-guiding element 2f, and at least one light-emitting element 3.

The light-guiding element 2f includes a light-guiding board 20f, a plurality of micro concave grooves 21f respectively formed on a top surface and a bottom surface of the light-guiding board 20f, and a transparent protective layer 22f respectively formed on the top surface and the bottom surface of the light-guiding board 20f for covering the micro concave grooves 21f. Hence, the difference between the seventh embodiment and the fourth embodiment is that there is no any material filled into the micro concave grooves 21f and the transparent protective layer 22f is covered over the micro concave grooves 21f.

Therefore, when the at least one light-emitting element 3 projects a light source S7 to the light-guiding element 2f, the light source S7 is guided via the light-guiding element 2f (via matching the light-guiding board 20f and the micro concave grooves 21f) onto the at least one key module 1 to illuminate images (not shown) on the at least one key module 1 for user to watch the images.

According to the first embodiment to the seventh embodiment, the present invention can increase light-refracting and light-reflecting efficiency via different refractive index between the light-guiding board and the micro light-guiding bodies or between the light-guiding board and the micro concave grooves (air), or via controlling

Moreover, because the micro light-guiding bodies (22a, 22b, 22c) are respectively filled into the micro concave grooves (21a, 21b, 21c) and the transparent protective layer (22d, 22e, 22f) are respectively covered over the micro concave grooves (21d, 21e, 21f), there is no any pollutants such as user's hand grimes filled into the micro concave grooves (21a, 21b, 21c, 21d, 21e, 21f).

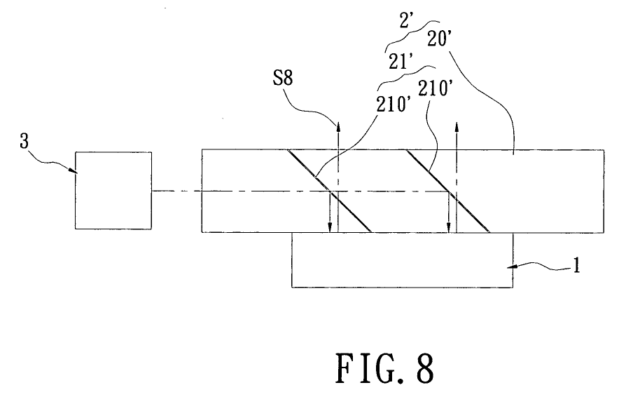

Referring to FIG. 8, the eighth embodiment of the present invention provides a light-guiding key structure with lateral light-guiding function, including at least one key module 1, a light-guiding element 2′, and at least one light-emitting element 3.

The light-guiding element 2′ includes a light-guiding board 20′ and a PBS (Polarizing Beam Splitter) module 21′ disposed in the light-guiding board 20′. The PBS module 21′ can be a polarizing beam splitting prism (or a polarizing beam splitting board) 210′ or can be composed of a plurality of polarizing beam splitting prisms (or polarizing beam splitting boards) 210′. The polarizing beam splitting prisms (or polarizing beam splitting boards) 210′ slantwise face to the at least one light-emitting element 3 and the at least one key module 1 for reflecting S-polarization or P-polarization of the light source S8 from the at least one light-emitting element 3 to the at least one key module 1.

Therefore, when the at least one light-emitting element 3 projects a light source S8 to the light-guiding element 2′, the light source S8 is guided via the light-guiding element 2′ (via matching the light-guiding board 20′ and the micro concave grooves 21′) onto the at least one key module 1 to illuminate images (not shown) on the at least one key module 1 for user to watch the images.

Furthermore, in the above-mentioned embodiments, the at least one key module can be a capacitance key module or a keypad display for providing pressing function (pressing the light-guiding element to indirectly press the at least one key module). Moreover, according to different design needs, the at least one key module can be composed of a plurality of key bodies that are separated from each other or can be composed of a plurality of key display that are separated from each other. In addition, the light-guiding element is separated from the at least one key module in a predetermined distance.

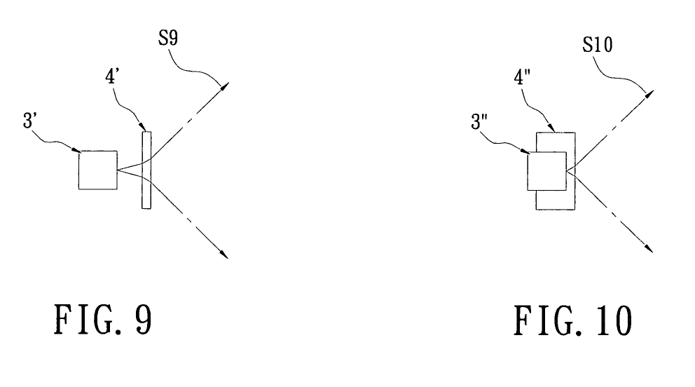

Referring to FIG. 9, the light-guiding key structure of the present invention further includes a light-transmitting material 4′ disposed beside the at least one light-emitting element 3′ for transmitting the light source S9 from different directions into a light-guiding element such as the light-guiding elements of the above-mentioned embodiments.

Referring to FIG. 10, the light-guiding key structure of the present invention further includes a light-transmitting material 4″ covered around the at least one light-emitting element 3″ for transmitting the light source S10 from different directions into a light-guiding element such as the light-guiding elements of the above-mentioned embodiments.

In conclusion, because the light-guiding material or the light-guiding structure of the present invention is disposed on/above the key body or the key display, the present invention utilizes less light sources to shows images with high brightness and high uniformity. The present invention has the following characteristics:

1. The present invention makes “point light source” transmitted into “face light source”, so less light-emitting elements can generate light source with high brightness. Hence brightness efficiency is increased.

2. Because the usage quantity of LEDs is decreased, the usage quantity of batteries is decreased. Hence, the charging frequency is decreased and the life of the battery is increased.

3. The present invention can use capacitance key module or keypad display, so the light-guiding key structure has a press-press function.

4. The opaque key body or the opaque key display can be applied to the present invention.

5. Because the light source is transmitted from “point light source” into “face light source”, so the entirety height of the present invention is decreased.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light-guiding key structure with lateral light-guiding function, comprising:
at least one key module;
a light-guiding element disposed over the at least one key module; and
at least one light-emitting element disposed beside one side of the light-guiding element;
whereby, when the at least one light-emitting element projects a light source to the light-guiding element, the light source is guided via the light-guiding element onto the at least one key module to illuminate images on the at least one key module for user to watch the images.

2. The light-guiding key structure as claimed in claim 1, wherein the at least one key module is an opaque.

3. The light-guiding key structure as claimed in claim 1, wherein the at least one key module is a capacitance key module or a keypad display.

4. The light-guiding key structure as claimed in claim 1, wherein the at least one key module is composed of a plurality of key bodies.

5. The light-guiding key structure as claimed in claim 1, wherein the at least one key module is composed of a plurality of key display.

6. The light-guiding key structure as claimed in claim 1, wherein the light-guiding element abuts against a top surface of the at least one key module.

7. The light-guiding key structure as claimed in claim 1, wherein the light-guiding element is separated from the at least one key module in a predetermined distance.

8. The light-guiding key structure as claimed in claim 1, further comprising a light-transmitting material disposed beside or covered around the at least one light-emitting element for transmitting the light source from different directions into the light-guiding element, wherein the at least one light-emitting element is an LED or is composed of a plurality of LEDs.

9. The light-guiding key structure as claimed in claim 1, wherein the light-guiding element is a light-guiding board.

10. The light-guiding key structure as claimed in claim 1, wherein the light-guiding element includes a light-guiding board with a first refractive index, a plurality of micro concave grooves formed on a top surface of the light-guiding board, and a plurality of micro light-guiding bodies respectively filled into the micro concave grooves, and each micro light-guiding body has a second refractive index different from the first refractive index of the light-guiding board.

11. The light-guiding key structure as claimed in claim 1, wherein the light-guiding element includes a light-guiding board with a first refractive index, a plurality of micro concave grooves formed on a bottom surface of the light-guiding board, and a plurality of micro light-guiding bodies respectively filled into the micro concave grooves, and each micro light-guiding body has a second refractive index different from the first refractive index of the light-guiding board.

12. The light-guiding key structure as claimed in claim 1, wherein the light-guiding element includes a light-guiding board with a first refractive index, a plurality of micro concave grooves respectively formed on a top surface and a bottom surface of the light-guiding board, and a plurality of micro light-guiding bodies respectively filled into the micro concave grooves, and each micro light-guiding body has a second refractive index different from the first refractive index of the light-guiding board.

13. The light-guiding key structure as claimed in claim 1, wherein the light-guiding element includes a light-guiding board, a plurality of micro concave grooves formed on a top surface of the light-guiding board, and a transparent protective layer formed on the top surface of the light-guiding board for covering the micro concave grooves.

14. The light-guiding key structure as claimed in claim 1, wherein the light-guiding element includes a light-guiding board, a plurality of micro concave grooves formed on a bottom surface of the light-guiding board, and a transparent protective layer formed on the bottom surface of the light-guiding board for covering the micro concave grooves.

15. The light-guiding key structure as claimed in claim 1, wherein the light-guiding element includes a light-guiding board, a plurality of micro concave grooves respectively formed on a top surface and a bottom surface of the light-guiding board, and a transparent protective layer respectively formed on the top surface and the bottom surface of the light-guiding board for covering the micro concave grooves.

16. The light-guiding key structure as claimed in claim 1, wherein the light-guiding element includes a light-guiding board and a PBS (Polarizing Beam Splitter) module disposed in the light-guiding board.

17. The light-guiding key structure as claimed in claim 16, wherein the PBS module is composed of a plurality of polarizing beam splitting prisms or polarizing beam splitting boards.

18. The light-guiding key structure as claimed in claim 17, wherein the polarizing beam splitting prisms or polarizing beam splitting boards slantwise face to the at least one light-emitting element and the at least one key module for reflecting S-polarization or P-polarization of the light source from the at least one light-emitting element to the at least one key module.
